(19) United States
(12) Patent Application Publication
(10) Pub. No.: US 2023/0327302 A1
(43) Pub. Date: Oct. 12, 2023

(54) Pouch cell and stack

(71) Applicant: Hilti Aktiengesellschaft, Schaan (LI)

(72) Inventors: Matthias LEPIORZ, Chemnitz (DE); Robert STANGER, Kaufbeuren (DE); Moses ENDER, Buchs (CH); Bernd ZIEGLER, Schabmunchen (DE); Klaus HAUSER, Schwabmunchen (DE); Nora MARTINY, Herrsching-Breitbrunn (DE); Kathrin SAX, Scheuring (DE)

(21) Appl. No.: 18/022,466

(22) PCT Filed: Aug. 11, 2021
(86) PCT No.: PCT/EP2021/072346

§ 371 Date: Feb. 21, 2023

(30) Foreign Application Priority Data
Aug. 25, 2020 (EP) 20192570.8

(51) Int. Cl. H01M 50/562; H01M 50/105; H01M 50/557; H01M 50/516; H01M 50/514

(52) U.S. Cl. CPC H01M 50/562; H01M 50/105; H01M 50/514; H01M 50/516; H01M 50/557

(57) ABSTRACT

Pouch cell having a positive contact lug and a negative contact lug, by means of which contact lugs electrical contact can be made with the pouch cell and the pouch cell can be charged and discharged in this way, wherein the pouch cell is of planar design and has a cell top side as well as a cell bottom side which is situated opposite the cell top side, wherein the positive contact lug has a conductive coating on the cell top side and an insulating coating on the cell bottom side and the negative contact lug has an insulating coating on the cell top side and a conductive coating on the cell bottom side, or vice versa, wherein the positive contact lug has an insulating coating on the cell top side and a conductive coating on the cell bottom side and the negative contact lug has a conductive coating on the cell top side and an insulating coating on the cell bottom side.

The present invention relates to a pouch cell having a positive contact lug and a negative contact lug, by means of which contact lugs electrical contact can be made with the pouch cell and said pouch cell can be charged and discharged in this way. The pouch cell is of planar design and has a cell top side as well as a cell bottom side which is situated opposite the cell top side. The present invention likewise relates to a stack having at least two such pouch cells.

### BACKGROUND

Such a pouch cell is known, for example, from EP 3 588 614 A1.

### SUMMARY OF THE INVENTION

An object of the present invention is to provide a pouch cell, a stack having at least two pouch cells as well as a method for producing a stack having a plurality of pouch cells which facilitate simple and secure contact-connection.

With regard to the pouch cell, the present invention provides that the positive contact lug has a conductive coating on the cell top side and an insulating coating on the cell bottom side and the negative contact lug has an insulating coating on the cell top side and a conductive coating on the cell bottom side, or vice versa, in that the positive contact lug has an insulating coating on the cell top side and a conductive coating on the cell bottom side and the negative contact lug has a conductive coating on the cell top side and an insulating coating on the cell bottom side.

The invention includes the finding that pouch cells are difficult to handle in mass production processes since their contact lugs are typically situated close to one another and the pouch cells can be short-circuited if they are not handled carefully. Furthermore, it was found that, on account of their construction, pouch cells previously could not be resistance-welded—or else at least could be resistance-welded with comparative difficulty—for the purpose of making electrical contact. In mass production processes of battery packs or stacks having pouch cells, this leads to a high level of technical and financial expenditure for automated installations which carry out electrical contact-connection of the individual pouch cells.

In a particularly preferred refinement, the insulating coating consists of ceramic or comprises ceramic. The conductive coating can consist of a tin alloy or comprise a tin alloy. It has been found to be advantageous if the conductive coating is applied in the form of a, in particular tin-containing, soldering paste. Flux components of the soldering paste typically evaporate when the contact lugs are fused or soldered.

It has been found to be advantageous if the positive contact lug consists of aluminum or comprises aluminum. The negative contact lug can consist of nickel or comprise nickel. In a further preferred refinement, the conductive coating consists of a material different to that of the contact lug. It has been found to be advantageous if the insulating coating consists of a material different to that of the contact lug.

In a further preferred refinement, the conductive coating is provided on a self-adhesive carrier material which is preferably applied or to be applied to a contact lug. The insulating coating can be provided on a self-adhesive carrier material, wherein the self-adhesive carrier material is preferably applied or to be applied to a contact lug.

It has been found to be advantageous if the positive contact lug and the negative contact lug are each flat and designed for contact-connection by means of pressing and/or by means of soldering. In a further preferred refinement, the cell top side and the cell bottom side are of substantially flat design.

In a further preferred refinement, the conductive coating has an electrical conductivity of at least 10E6 S/m. It has been found to be advantageous if the insulating coating has an electrical conductivity of less than 10E−8 S/m.

With regard to the stack, the present invention provides that a first, in particular only the first, of the two pouch cells is developed in such a way that the positive contact lug has a conductive coating on the cell top side and an insulating coating on the cell bottom side and the negative contact lug has an insulating coating on the cell top side and a conductive coating on the cell bottom side, or in that the positive contact lug has an insulating coating on the cell top side and a conductive coating on the cell bottom side and the negative contact lug has a conductive coating on the cell top side and an insulating coating on the cell bottom side, and wherein the complementary contact lugs of the two pouch cells respectively overlap. It has been found to be advantageous if the complementary contact lugs overlap in the stacking direction. In a particularly preferred refinement, complementary contact lugs are congruent in the stacking direction. Complementary contact lugs are intended to be understood to mean, in particular, the pairing of a positive contact lug of the pouch cells of a first type with a negative contact lug of the pouch cell of a second type and/or the pairing of a negative contact lug of the pouch cell of the first type with a positive contact lug of the pouch cell of the second type. In a further preferred refinement, a plurality of first and second pouch cells are provided and are stacked alternately. In the context of the present application, a first pouch cell is intended to be understood to mean, in particular, a pouch cell of a first type. In the context of the present application, a second pouch cell is intended to be understood to mean, in particular, a pouch cell of a second type. It has been found to be advantageous if the first pouch cell is developed in accordance with the features described with reference to the pouch cell.

In a particularly preferred refinement, the pouch cells are electrically contact-connected to one another via their respective connecting elements. Adjacent pouch cells are preferably electrically connected to one another in series. A plurality of stacks of pouch cells that are electrically interconnected in this way can be electrically connected in parallel so—for example as part of a battery pack—as to serve to supply power to an electric handheld power tool.

With regard to the stack, the present invention also provides a method comprising the following steps:
providing a plurality of pouch cells, wherein the pouch cells are each equipped with a positive contact lug and a negative contact lug, by means of which contact lugs electrical contact can be made with the pouch cells and said pouch cells can be charged and discharged in this way, wherein the pouch cells are of planar design and have a cell top side as well as a cell bottom side which is situated opposite the cell top side,
carrying out a coating process for a subset, preferably for half, of the pouch cells in such a way that the positive contact lug has a conductive coating on the cell top side and an insulating coating on the cell bottom side and the negative contact lug has an insulating coating on the cell top side and a conductive coating on the cell bottom side, or in that the positive contact lug has an insulating coating on the cell top side and a conductive coating on the cell bottom side and the negative contact lug has a conductive coating on the cell top side and an insulating coating on the cell bottom side, wherein the pouch cells coated in this way define a first type and the remaining pouch cells form a second type,
assembling the stack by alternately stacking the pouch cells of the first and the second type, wherein complementary contact lugs of the pouch cells respectively overlap.

It has been found to be advantageous if the coating process is carried out before the step of assembling the stack. As an alternative, the coating process can be carried out after the step of assembling the stack. In this alternative, it has been found to be advantageous if the coating process involves applying a self-adhesive carrier material on which the conductive coating and/or the insulating coating are/is respectively provided.

In a particularly preferred refinement, the stack is electrically contact-connected by pressing and/or by fusing.

Further advantages will become apparent from the following description of the figures. Various exemplary embodiments of the present invention are illustrated in the figures. The figures, the description and the claims contain numerous features in combination. A person skilled in the art will expediently also consider the features individually and combine them to form useful further combinations.

### BRIEF DESCRIPTION OF THE DRAWINGS

In the figures, identical and similar components are denoted by the same reference signs. In the figures:

FIG. 1 shows a pouch cell of the prior art;

FIG. 2 shows a first preferred exemplary embodiment of a pouch cell according to the invention;

FIG. 3 shows a first preferred exemplary embodiment of a stack according to the invention; and

FIG. 4 shows a first preferred exemplary embodiment of a method according to the invention;

### DETAILED DESCRIPTION

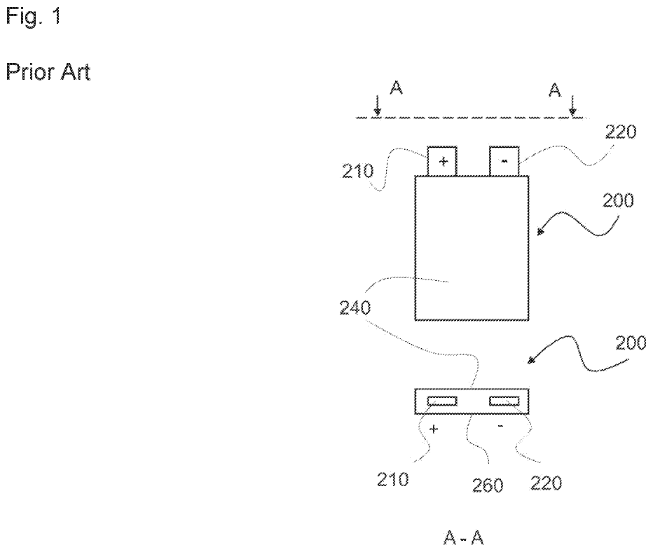

A pouch cell 200 of the prior art is illustrated in FIG. 1. The pouch cell 200 is equipped with a positive contact lug 210 and a negative contact lug 220, by means of which contact lugs electrical contact can be made with the pouch cell 200 and said pouch cell can be charged and discharged in this way. The pouch cell 200 is of planar design and has a cell top side 240 as well as a cell bottom side 260 which is situated opposite the cell top side 210.

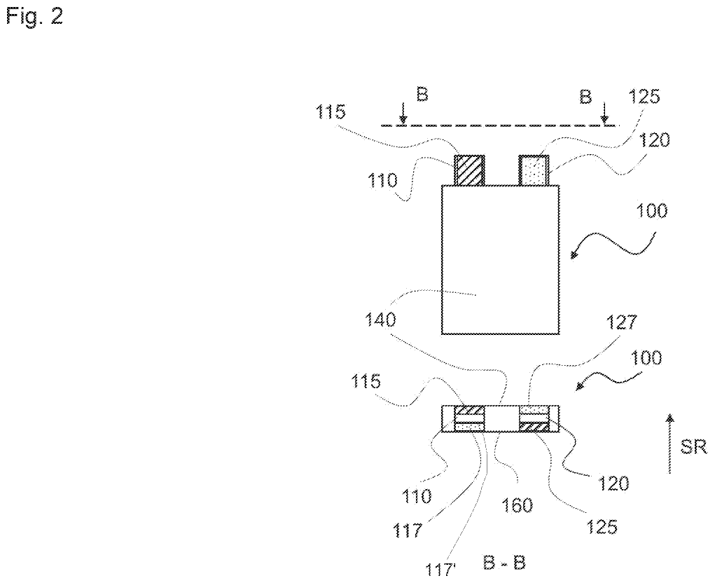

A preferred exemplary embodiment of a pouch cell 100 according to the invention is illustrated in FIG. 2. The pouch cell 100 is equipped with a positive contact lug 110 and a negative contact lug 120, by means of which contact lugs electrical contact can be made with the pouch cell 100 and said pouch cell can be charged and discharged in this way. Here, the positive contact lug 110 consists of aluminum, by way of example. The negative contact lug 120 consists of nickel, by way of example. The cell top side 140 and the cell bottom side 160 of the pouch cell are substantially flat.

The cell top side 140 of the pouch cell 100 is understood to mean, in particular, that flat side of the pouch cell 100 which is at the top in the stacking direction SR when looking at the end side of the pouch cell 100 and the positive contact lug 110 is located to the left of the negative contact lug 120. The cell bottom side 140 of the pouch cell 100 is understood to mean, in particular, that flat side of the pouch cell 100 which is at the bottom in the stacking direction SR when looking at the end side of the pouch cell 100 and the positive contact lug 110 is located to the left of the negative contact lug 120. This is respectively the case in the lower view B-B of FIG. 2.

As can be gathered from FIG. 2, the positive contact lug 110 has, on the cell top side 140, a conductive coating 115 which is provided, by way of example, in the form of a tin-containing soldering paste. The positive contact lug 110 has, on the cell bottom side 160, an insulating coating 117 which is provided, by way of example, in the form of a ceramic, for example using a self-adhesive carrier material 117′. The negative contact lug 120 is equipped, on the cell top side 140, with an insulating coating 127 in the form of a ceramic. The negative contact lug 120 has, on the cell bottom side 160, a conductive coating 125 in the form of a tin-containing soldering paste. The coatings 115, 117, 125, 127 substantially completely cover the respective surfaces of the contact lugs 110, 120.

The insulating coating 117 of the positive contact lug 110 and the insulating coating 127 of the negative contact lug 120 consist of, by way of example, the same material. The conductive coating 115 of the positive contact lug 110 and the conductive coating 125 of the negative contact lug 120 consist of, by way of example, the same material. Neither of these necessarily has to be the case.

In an alternative exemplary embodiment, the contact lugs can be coated the other way around in principle, namely in such a way that the positive contact lug has an insulating coating on the cell top side and a conductive coating on the cell bottom side and the negative contact lug has a conductive coating on the cell top side and an insulating coating on the cell bottom side. It has been found to be advantageous if an initially selected coating alternative is retained in a batch (or in the case of a stack).

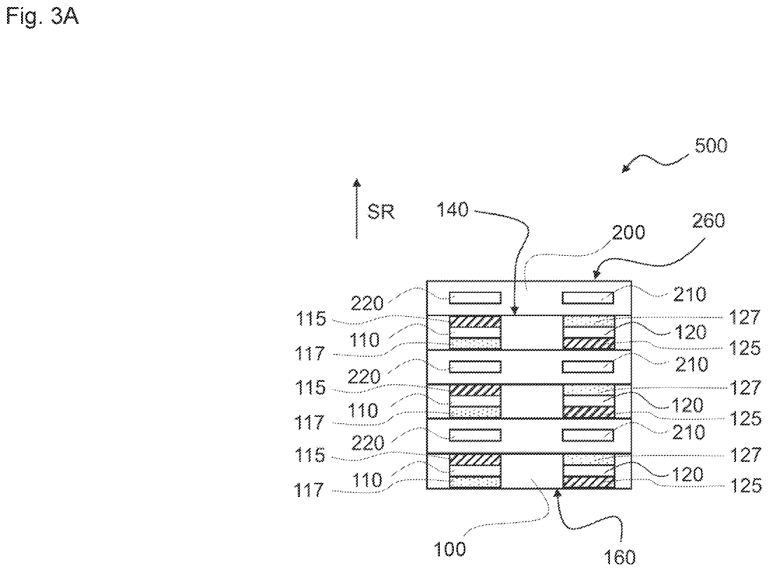

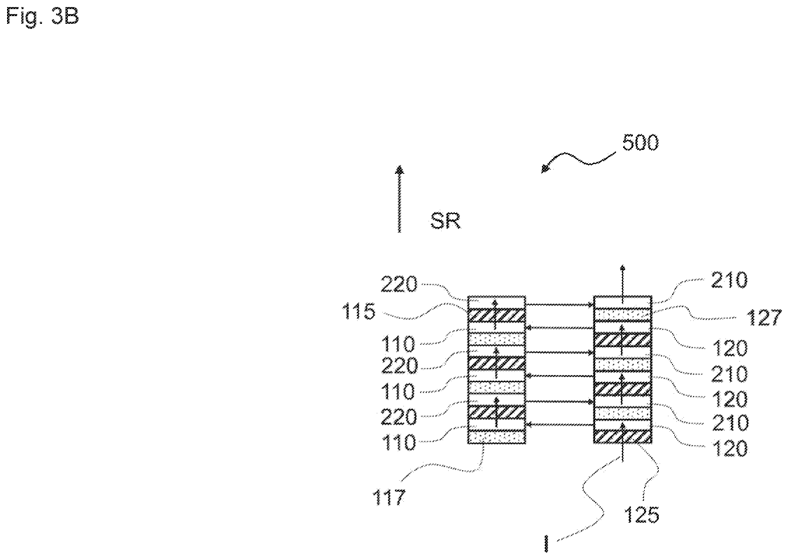

The pouch cell 100 of FIG. 2 creates the basis for simple and secure contact-connection of a stack 500, this being explained in more detail below with reference to FIG. 3. Here, FIG. 3A shows the stack 500 in the assembled state, i.e. before the electrical contact-connection. The electrically contact-connected stack 500 is illustrated in FIG. 3B.

The stack 500 has, by way of example, six pouch cells 100, 200 which are stacked in the stacking direction SR. Three pouch cells 100 are of the first type, i.e. the positive contact lug 110 has a conductive coating 115 on the cell top side and an insulating coating 117 on the cell bottom side and the negative contact lug 120 has an insulating coating 127 on the cell top side and a conductive coating 125 on the cell bottom side. The three pouch cells 100 of the first type correspond to the exemplary embodiment of FIG. 2. Three pouch cells 200 are of the second type, i.e. they correspond to pouch cells of the prior art, shown in FIG. 1. In other words, out of a total of, here by way of example, six pouch cells, half are of the first type and the other half are of the second type. Only the pouch cells 100 of the first type are developed in accordance with the exemplary embodiment of FIG. 2.

The pouch cells 100 of the first type and the pouch cells 200 of the second type are respectively stacked alternately, i.e. from bottom to top as seen in the stacking direction SR in the exemplary embodiment shown: Pouch cell 100 of the first type, pouch cell 200 of the second type, pouch cell 100 of the first type, etc. Here, the pouch cells 200 of the second type are rotated through 180 degrees with respect to the stacking direction SR, so that the positive contact lugs 110 of the pouch cells 100 of the first type overlap, in particular are congruent, with the negative contact lug 220 of the pouch cells 200 of the second type in the stacking direction. The negative contact lugs 120 of the pouch cells 100 of the first type overlap with the positive contact lugs 210 of the pouch cells 200 of the second type in the stacking direction. In the exemplary embodiment of FIG. 3, the negative contact lugs 120 of the pouch cells 100 of the first type are congruent with the positive contact lugs 210 of the pouch cells 200 of the second type.

The electrically contact-connected stack 500 is illustrated in FIG. 3B. Electrical contact-connection can be performed, for example, by means of pressing in the stacking direction SR and/or by means of soldering. For reasons of illustration, the contours of the pouch cells are not illustrated in FIG. 3B. It should likewise be pointed out that a layer thickness of a conductive coating 115—if this is provided, for example, in the form of soldering paste—typically decreases over the course of soldering. Due to the alternating stacking of the pouch cells of the first type and the pouch cells of the second type, wherein the pouch cells of the second type are rotated through 180 degrees with respect to the stacking direction SR, an electrical series connection is produced in the stack 500. The final flow of current I (physical current direction) is indicated by the directional arrows. Here, the horizontal directional arrows indicate the current flow within a respective pouch cell, and the vertical directional arrows indicate a current flow between contact lugs of respectively adjacent cells.

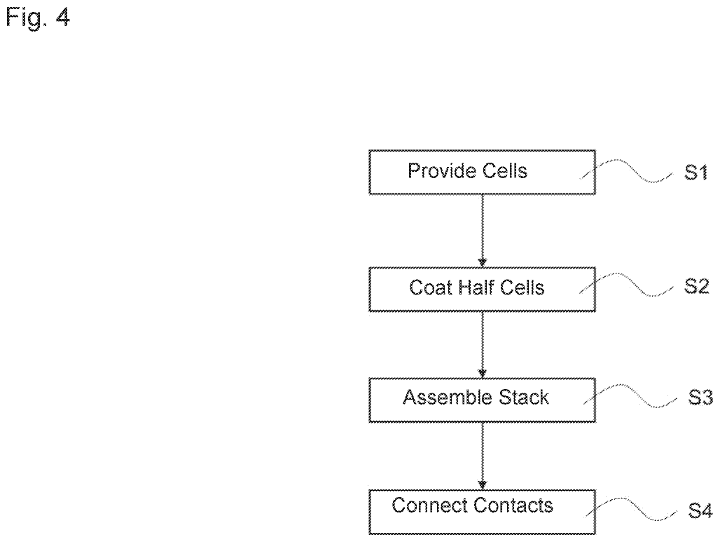

Finally, FIG. 4 shows a first preferred exemplary embodiment of a method according to the invention for producing a stack having a plurality of pouch cells. The stack 500 illustrated in FIG. 3B, for example, can be obtained by such a method.

In a first step S1, a plurality of pouch cells are provided, wherein the pouch cells are each equipped with a positive contact lug and a negative contact lug, by means of which contact lugs electrical contact can be made with the pouch cells and said pouch cells can be charged and discharged in this way. The pouch cells are of planar design and have a cell top side as well as a cell bottom side which is situated opposite the cell top side.

In a subsequent step S2, half of the pouch cells are subject to a coating process in such a way that the positive contact lug has a conductive coating on the cell top side and an insulating coating on the cell bottom side and the negative contact lug has an insulating coating on the cell top side and a conductive coating on the cell bottom side. The pouch cells obtained in this way define a first type (cf. FIG. 2). The remaining pouch cells (the respective contact lugs are not additionally coated) define a second type (cf. FIG. 1).

In a subsequent step S3, the stack is assembled by alternately stacking the pouch cells of the first and the second type, wherein complementary contact lugs of the pouch cells are each congruent in the stacking direction (cf. FIG. 3A).

In a subsequent step S4, the stack is electrically contact-connected by pressing (applying pressure in the stacking direction) and soldering (thermally induced). At the end of step 4, a stack as illustrated in FIG. 3B is present, for example.

### LIST OF REFERENCE SIGNS

100 Pouch cell
110 Positive contact lug
115 Conductive coating
117 Insulating coating
120 Negative contact lug
125 Conductive coating
127 Insulating coating
140 Cell top side
160 Cell bottom side
200 Pouch cell of the prior art
210 Positive contact lug
220 Negative contact lug
240 Cell top side
260 Cell bottom side
I Current
SR Stacking direction
S1.S4 Method steps

What is claimed is:

1-13. (canceled)

14. A pouch cell comprising:
a positive contact lug; and
a negative contact lug, electrical contact and a charging and discharging achievable for the pouch cell via the positive and negative contact lugs,
the pouch cell being of planar design defining a cell top side and a cell bottom side situated opposite the cell top side;
the positive contact lug having a conductive coating on the cell top side and an insulating coating on the cell bottom side and the negative contact lug having an insulating coating on the cell top side and a conductive coating on the cell bottom side, or vice versa, the positive contact lug having an insulating coating on the cell top side and a conductive coating on the cell bottom side and the negative contact lug having a conductive coating on the cell top side and an insulating coating on the cell bottom side.

15. The pouch cell as recited in claim 14 wherein the insulating coating consists of ceramic or comprises ceramic.

16. The pouch cell as recited in claim 14 wherein the conductive coating consists of a tin alloy or comprises a tin alloy.

17. The pouch cell as recited in claim 14 wherein the positive contact lug consists of aluminum or comprises aluminum.

18. The pouch cell as recited in claim 14 wherein the negative contact lug consists of nickel or comprises nickel.

19. The pouch cell as recited in claim 14 wherein the conductive coating or the insulating coating consists of a material different to that of the contact lugs.

20. The pouch cell as recited in claim 14 wherein the conductive coating or the insulating coating is provided on a self-adhesive carrier material.

21. The pouch cell as recited in claim 14 wherein the positive contact lug and the negative contact lug are each flat and designed for contact-connection via pressing or soldering.

22. The pouch cell as recited in claim 14 wherein the cell top side and the cell bottom side are substantially flat.

23. The pouch cell as recited in claim 14 wherein the insulating coating on the positive contact lug and the insulating coating on the negative contact lug are of a same material or the conductive coating on the positive contact lug and the conductive coating on the negative contact lug are of a same material.

24. A stack comprising:
at least two pouch cells, wherein the pouch cells are each equipped with a positive contact lug and a negative contact lug, electrical contact and a charging and discharging achievable for the pouch cell via the positive and negative contact lugs, the pouch cells being of planar design defining a cell top side and a cell bottom side situated opposite the cell top side;
a first of the at least two pouch cells having the positive contact lug having a conductive coating on the cell top side and an insulating coating on the cell bottom side and the negative contact lug having an insulating coating on the cell top side and a conductive coating on the cell bottom side, or visa versa, the positive contact lug having an insulating coating on the cell top side and a conductive coating on the cell bottom side and the negative contact lug having a conductive coating on the cell top side and an insulating coating on the cell bottom side,
complementary contact lugs of the at least two pouch cells respectively overlapping.

25. The stack as recited in claim 24 wherein the second of the at least two pouch cells does not have the insulating and the conductive coatings of the first of the at least two pouch cell.

26. The stack as recited in claim 24 wherein a plurality of first and second pouch cells are provided and are stacked alternately.

27. The stack as recited in claim 24 wherein the pouch cells are electrically contact-connected to one another via respective contact lugs.

28. A method for producing a stack having a plurality of pouch cells, the method comprises the following steps:
providing a plurality of pouch cells, wherein the pouch cells are each equipped with a positive contact lug and a negative contact lug, electrical contact and a charging and discharging achievable for the pouch cell via the positive and negative contact lugs, the pouch cells being of planar design defining a cell top side and a cell bottom side situated opposite the cell top side,
carrying out a coating process for a subset of the pouch cells in such a way that the positive contact lug has a conductive coating on the cell top side and an insulating coating on the cell bottom side and the negative contact lug has an insulating coating on the cell top side and a conductive coating on the cell bottom side, or in that the positive contact lug has an insulating coating on the cell top side and a conductive coating on the cell bottom side and the negative contact lug has a conductive coating on the cell top side and an insulating coating on the cell bottom side, wherein the pouch cells coated in this way define a first type and the remaining pouch cells form a second type, and
assembling the stack by alternately stacking the pouch cells of the first and the second type so complementary contact lugs of the pouch cells respectively overlap.

29. The method as recited in claim 28 wherein the subset is half of the plurality of pouch cells.

30. The method as claimed in claim 28 wherein the stack is electrically contact-connected by pressing or soldering.
